(19) United States
(12) Patent Application Publication
(10) Pub. No.: US 2026/0142935 A1
(43) Pub. Date: May 21, 2026

(54) DIGITAL SIGNAL PROCESSOR (DSP) INTEGRATION OF LAYER 2/3 PROTOCOLS AND CROSSBAR CONTROL IN NETWORK SWITCHING

(71) Applicant: MaxLinear, Inc., Carlsbad, CA (US)

(72) Inventors: Curtis Ling, Carlsbad, CA (US); Masoud Koochakzadeh, Carlsbad, CA (US); Sheng Ye, Carlsbad, CA (US); John Andrew Guckenberger, Carlsbad, CA (US); Sridhar Ramesh, Carlsbad, CA (US)

(73) Assignee: MaxLinear, Inc., Carlsbad, CA (US)

(21) Appl. No.: 19/397,702

(22) Filed: Nov. 21, 2025

Related U.S. Application Data
(60) Provisional application No. 63/723,528, filed on Nov. 21, 2024.

(51) Int. Cl. H04L 49/101; H04L 45/745; H04L 61/103; H04L 69/22; H04L 101/622

(52) U.S. Cl. CPC H04L 49/101; H04L 45/745; H04L 61/103; H04L 69/22; H04L 2101/622

(57) ABSTRACT

A device may include a processor operable to process one or more of layer 2(L2) or layer 3 (L3) protocols in which the processor includes handling of one or more of frame headers, frame boundaries, media access control (MAC) addresses, or internet protocol (IP) addresses. The device may have a MAC address and an IP address associated with the device. The device may be operable to receive and process data packets addressed to the MAC or the IP address of the device. The device may be operable to interface with layer 1(L1) devices, including layer 1 systems and physical transceivers (PHYs).

### RELATED APPLICATION

This application claims the benefit of U.S. Provisional Application No. 63/723,528, filed Nov. 21, 2024, the disclosure of which is incorporated herein by reference in its entirety.

The examples discussed in the present disclosure are related to digital signal processor (DSP) integration of layer ⅔ protocols and crossbar control in network switching.

### BACKGROUND

Unless otherwise indicated herein, the materials described herein are not prior art to the claims in the present application and are not admitted to be prior art by inclusion in this section.

In modern network infrastructure, efficient traffic management and protocol handling across multiple layers of the network stack may be advantageous to ensuring high performance, low latency, and scalability. Traditionally, the responsibilities of Layer 1 (L1), Layer 2 (L2), and Layer 3 (L3) in networking have been divided among dedicated hardware components, with L1 handling physical transmission, L2 managing MAC address-based switching, and L3 performing IP-based routing. This separation, while effective, introduces latency due to handoffs between the various hardware layers and lacks the flexibility to adapt to dynamic network conditions. As network traffic grows more complex, with the demand for real-time processing of high-priority data such as video streams, voice-over-IP (VoIP), and secure transactions, there is an increasing use for network switches to perform more intelligent and adaptive traffic management across layers.

### SUMMARY

Accordingly, some examples described herein include a system in which the DSP may perform Layer 2 and Layer 3 protocol processing, enabling it to handle MAC address tables, routing tables, and traffic priority directly. The DSP may also control crossbar switches, enabling real-time configuration and data routing with reduced latency. This integration may allow for faster response to data requests and better resource management by allowing the DSP to make decisions based on protocol-level data without relying on external control.

The objects and advantages of the examples will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

So that the manner in which the above recited features of the present disclosure can be understood in detail, a more particular description of the disclosure, briefly summarized above, may be had by reference to examples, some of which are illustrated in the appended drawings. It is noted, however, that the appended drawings illustrate only some aspects of this disclosure and the disclosure may admit to other equally effective examples.

To facilitate understanding, identical reference numerals have been used, where possible, to designate identical elements that are common to the figures. It is contemplated that elements and features of one example may be beneficially incorporated in other examples without further recitation.

FIGS. 1A-1B illustrates a schematic of an exemplary switch system;

FIG. 2 illustrates a schematic of an exemplary switch system;

FIG. 3 illustrates a schematic of an exemplary switch system;

FIG. 4 illustrates a flow diagram corresponding to an exemplary switch system;

FIG. 5 illustrates an example communication system, in accordance with some embodiments; and

FIG. 6 illustrates a schematic of an exemplary computing device, in accordance with some embodiments.

FIG. 7A illustrates an example block diagram of a data center.

FIG. 7B illustrates an example switch device.

FIG. 7C illustrates an example switch device.

FIG. 7D illustrates an example switch device.

### DETAILED DESCRIPTION

The present disclosure will now be described in detail with reference to the drawings, which are provided as illustrative examples of the disclosure so as to enable those skilled in the art to practice the disclosure. Notably, the figures and examples below are not meant to limit the scope of the present disclosure to a single example, but other examples are possible by way of interchange of some or all of the described or illustrated elements. Moreover, where certain elements of the present disclosure can be partially or fully implemented using known components, only those portions of such known components that are necessary for an understanding of the present disclosure will be described, and detailed descriptions of other portions of such known components will be omitted so as not to obscure the disclosure.

The examples described herein present a highly efficient and integrated solution for network switches by expanding the role of Digital Signal Processors (DSPs) beyond traditional Layer 1 (L1) signal processing. For example, some network devices segregate physical, data link, and network layer tasks across different hardware components, resulting in increased latency and limited scalability. The examples herein redefine the boundaries of DSP functionality by incorporating Layer 2 (L2) and Layer 3 (L3) protocol processing directly within the DSP at the physical layer, which reduces reliance on external processors for tasks like MAC address lookups, packet forwarding, and IP routing. By handling these functions at the physical layer, DSPs optimize the overall data flow, reducing the time needed to process and route network traffic.

Digital Signal Processors (DSPs) have emerged as a versatile solution capable of handling complex tasks beyond traditional physical layer processing. By integrating L2 and L3 functions directly within the DSP, network switches can perform real-time packet inspection, MAC and IP address lookups, traffic prioritization, and advanced protocol management at the physical layer. This expanded role of DSPs enables simultaneous processing of L2/L3 tasks, reduces latency, and enhances the ability of network devices to handle dynamic traffic loads. Furthermore, DSPs bring programmability, flexibility, and real-time optimization to protocol handling, allowing network systems to dynamically adapt to changing network conditions and support higher bandwidth demands while ensuring optimal resource allocation and traffic flow management.

DSPs include the ability to simultaneously process L2 and L3 protocols while performing traditional L1 functions. Such parallel processing capability allows the DSP to inspect and manage MAC address tables for L2 operations and perform IP address lookups for L3 routing in real time. This capability enables faster forwarding decisions within the network switch, because the packet inspection and routing decisions are made directly at the physical layer, minimizing the delays caused by transferring data between L2 and L3 hardware components. As a result, the overall latency may be significantly reduced, such as in environments with high data throughput, such as data centers and telecom networks.

Some examples further enhance network efficiency through dynamic traffic management features. The programmable nature of the DSP allows for real-time adjustments to network traffic priorities. For instance, advantageous data streams such as VoIP, video conferencing, or financial transactions can be prioritized over lower-priority traffic based on real-time network conditions. The DSP can dynamically allocate bandwidth, adjust flow control, and optimize packet scheduling, ensuring that high-priority traffic experiences minimal latency and congestion. This may be useful in complex networking environments that require strict adherence to Quality of Service (QoS) standards.

In addition to prioritizing traffic, some examples of the DSP enable advanced load balancing across multiple paths or ports. By continuously monitoring traffic flow and path utilization, the DSP may distribute traffic more evenly across available network resources, preventing bottlenecks and ensuring that all network paths are used efficiently. In scenarios where certain paths are congested or underutilized, the DSP may reroute traffic dynamically to optimize throughput. This adaptive traffic distribution capability enhances overall network resilience and ensures smoother traffic flow, even under heavy loads.

Another significant advantage of some examples is their ability to perform flow control and congestion management. The DSPs may proactively detect network congestion and apply mechanisms such as backpressure to slow down data flows from sources contributing to the congestion. By managing traffic at the physical layer, DSPs may control how data packets are processed, buffered, or queued, ensuring that the network remains stable even during peak traffic conditions. The DSP's ability to handle tasks like Time-Division Multiplexing (TDM) for resource allocation further supports the efficient sharing of network bandwidth across multiple data streams.

Some embodiments also incorporate enhanced security features by integrating packet inspection and encryption at the DSP level. Traditionally, encryption and packet inspection are handled by separate security processors, which can introduce additional delays in packet processing. By integrating these security functions within the DSP, the switch can perform real-time encryption and decryption, ensuring secure transmission without sacrificing speed. Furthermore, the DSP can implement security policies such as packet filtering and monitoring for malicious traffic patterns, providing an additional layer of defense while maintaining network performance.

Finally, the scalability of some examples is a significant advantage. By offloading L2 and L3 tasks to the DSP, the overall hardware complexity of the network switch is reduced, enabling more straightforward scaling of network infrastructure. This architecture allows for higher data throughput without using additional external hardware for protocol handling. The flexibility and programmability of DSPs ensure that as network traffic grows, new features and optimizations may be implemented via software updates rather than expensive hardware upgrades, providing a cost-effective solution for modern, high-speed networks.

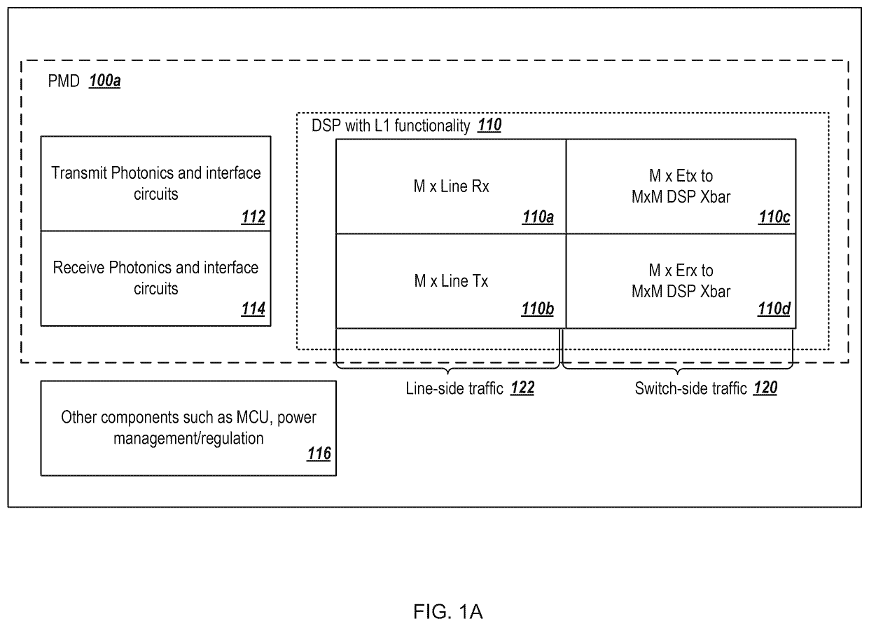

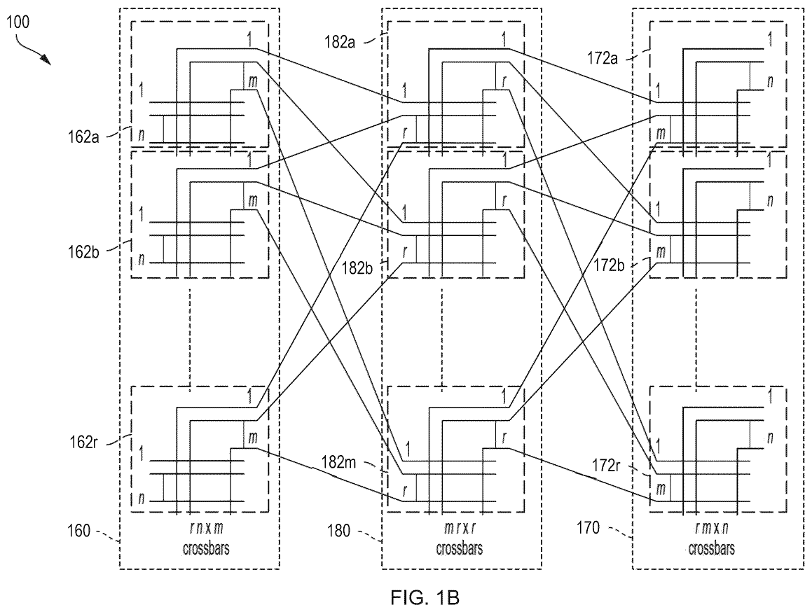

Referring now to FIG. 1A-1B, FIG. 1A illustrates an example of a Physical Media Dependent (PMD) device 100a, which may handle line-side traffic and switch-side traffic through integrated components, including a digital signal processor (DSP) 110 with L1 functionality, photonics interface circuits 112 and 114, and other supporting circuitry 116.

The PMD device 100a may serve as an advantageous element in high-speed data networking, enabling the transfer of data between the line-side (e.g., external data sources or links) and the switch-side (e.g., core network or switching infrastructure). In the illustrated example, PMD 100a includes multiple components designed to manage, process, and transfer data efficiently at the physical layer (Layer 1 or L1), with optional capability for higher-layer functionality in other examples.

At the core of PMD 100a is the Digital Signal Processor (DSP) 110, which is configured to handle Layer 1 (L1) functions such as signal processing, data transmission, and reception at high speeds. In this example, DSP 110 primarily facilitates L1 processing, enabling the conversion, synchronization, and management of data signals as they transition between the line-side and switch-side traffic paths. DSP 110 may include several components and configurations:
In some examples, the M×Line Rx block 110a within DSP 110 may receive line-side traffic 122, where “M” refers to the number of input lanes supported by the PMD for incoming data from external sources. The DSP may handle and condition incoming signals to ensure data integrity and optimize signal quality.

In some examples, the M×Line Tx block 110b may manage outgoing line-side traffic 122, transmitting data from the PMD to the external environment. Similar to the Rx (receive) block, the Tx (transmit) block is designed for high-speed data handling and may incorporate features such as equalization or error correction to maintain data quality.

### M×ETx 110c to M×M DSP Xbar 110c and M×ERx to M×M DSP Xbar 110d Components

represent the transmit and receive connections to the M×M DSP crossbar (Xbar) for switch-side traffic 120. The crossbar may enable flexible and dynamic routing of data across multiple lanes, allowing data from each line-side lane to be directed to any switch-side lane. The Xbar structure may be beneficial for scalability and provide the adaptability used in high-capacity network switches.

The Transmit Photonics and Interface Circuits 112 may manage the conversion of electrical signals to optical signals for data being transmitted from PMD 100a to external optical networks or devices. These circuits may include components such as laser drivers, modulators, and signal conditioners that ensure the outgoing data is optimized for optical transmission. The transmit photonics interface works closely with the M×Line Tx block 110b within DSP 110 to handle data efficiently while minimizing signal degradation during conversion.

The Receive Photonics and Interface Circuits 114 may perform the complementary function of converting incoming optical signals from the network back into electrical signals for processing within the PMD 100a. This block may include photodetectors, amplifiers, and signal equalizers to recover the data accurately and prepare it for processing by the M×Line Rx block 110a within DSP 110. The receive interface may ensure that incoming signals maintain integrity and are correctly synchronized for further processing within the DSP.

PMD 100a also includes Other Components 116, which may provide support functions to maintain the device's operation and efficiency. This may include: Microcontroller Unit (MCU): The MCU may provide local control over the DSP and photonics interfaces, managing configuration, fault detection, and operational adjustments as used by the network environment. Power Management and Regulation circuits may ensure that components within the PMD 100a receive stable and appropriate power levels. Power regulation may be advantageous in high-speed networking components to prevent overheating and ensure consistent performance, especially in data centers or environments where multiple PMD units may be deployed.

Line-Side Traffic 122 may represent the data flow between the PMD and external data sources or connections. The DSP's line-side Rx and Tx components may manage the flow of incoming and outgoing data at the physical layer, handling tasks such as error correction, signal conditioning, and data conversion between electrical and optical formats.

Switch-Side Traffic 120 may correspond to the internal data routing within a network switch, where PMD 100a directs data to and from other internal components through the DSP crossbar. Such traffic may be processed by the M×M DSP Xbar, which may allow for flexible and efficient data routing for high-performance network switching.

Data Reception (Rx Path) may correspond to data entering PMD 100a through the receive photonics interface 114, where it may be converted from an optical signal to an electrical signal. The signal may then pass to M×Line Rx 110a within DSP 110, where it may undergo L1 processing for signal conditioning and integrity checks. Finally, the data may be routed via M×ERx to the M×M DSP Xbar 110d for further handling within the switch-side environment.

Data Transmission (Tx Path) corresponds to outgoing data. DSP 110's M×Line Tx block 110b may prepare the electrical signal, which may be then passed to the transmit photonics interface 112, where the signal may be converted from an electrical format to an optical signal, optimized for transmission across an optical network.

The DSP crossbar (Xbar) may provide a flexible switching matrix that may allow line-side traffic to be dynamically mapped to any switch-side path, supporting efficient data routing and enabling the PMD to adapt to various traffic patterns and network configuration. For clarity, a brief review of crossbars follows.

For example, within PMD 100a, the DSP 110 may leverage an M×M crossbar (i.e., xbar) to manage and control data flow between line-side and switch-side traffic efficiently. This crossbar arrangement may allow for flexible data routing, supporting dynamic switching across multiple input and output paths. To provide further clarity on how this structure enables efficient data handling and low-latency routing, a brief review follows.

FIG. 1B illustrates exemplary underlying cross bar configurations. Crossbars may be specialized switching matrices that may allow connections between multiple input and output ports. They enable data from any input to be dynamically routed to any output, depending on the desired data path. In high-performance network applications, crossbars support flexible and efficient data flow, especially in configurations that have dynamic routing and low latency.

FIG. 1B illustrates a schematic of interconnected crossbars with n×m 160, r×r 180, and m×n 170 configurations, representing different crossbar sizes and configurations used within the system. The n×m 160 crossbars manage initial data input, distributing data across multiple paths based on pre-determined routing rules or real-time decisions. The r×r 180 crossbars in the center may act as intermediate switching nodes, further enabling data from any input on one side to be routed to any output on the other side. These r×r 180 crossbars may be advantageous for handling high data traffic within complex network structures, because they allow for extensive interconnections across all potential data paths. The m×n 170 crossbars handle the data outputs, directing data from the intermediate crossbars to the final output destinations.

The configuration depicted in FIG. 1B illustrates a flexible architecture where each input port may connect to any output port via a combination of these crossbars, providing a foundation for efficient, scalable data routing in high-capacity network systems. The interconnections between these crossbars may represent the data paths established between input and output lines. Each block, or crossbar can handle multiple simultaneous connections, allowing for a high degree of flexibility in data routing.

The depicted configuration allows data to traverse multiple crossbar stages, enabling complex routing patterns and supporting high bandwidth requirements typical in modern network switches. By structuring the crossbars in this manner, the system may maintain data flow continuity and avoid congestion, even under high traffic loads. Each stage of crossbars may provide additional routing options and help optimize data flow paths across the network infrastructure.

For example, in FIG. 1A, the DSP 110 within PMD 100a may interface with an M×M DSP crossbar to manage both line-side traffic 122 and switch-side traffic 120. The crossbars, as illustrated in FIG. 1B, serve as the underlying switching elements that enable DSP 110 to dynamically route data based on real-time traffic conditions and routing. Such crossbars provide the flexibility to map any line-side input to any switch-side output, or vice versa, through configurable connections controlled by the DSP. This capability may optimize data flow and minimize latency within the network. By employing crossbar structures similar to those in FIG. 1B, PMD 100a may efficiently handle complex data routing tasks while adapting to varying network demands, showcasing the versatility and scalability of crossbar-based network switching.

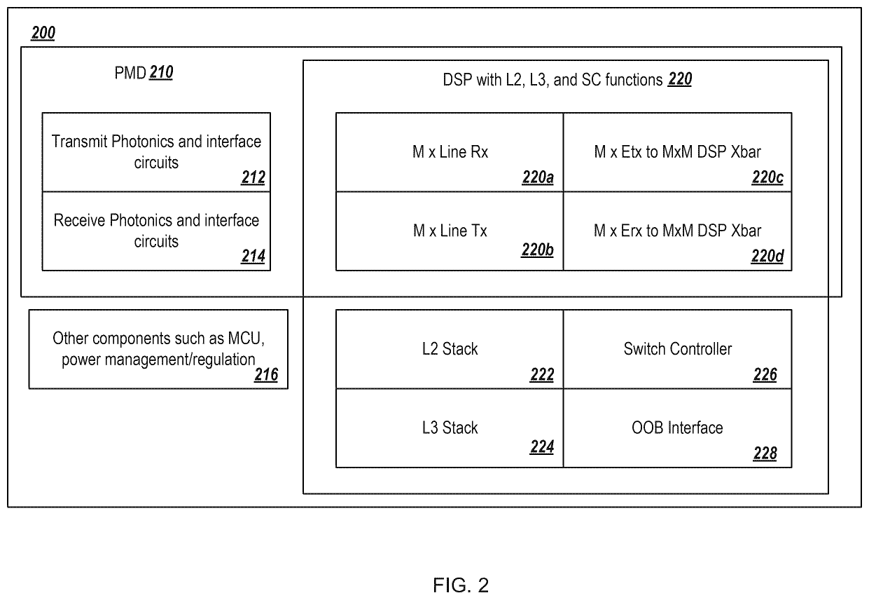

FIG. 2 illustrates a device 200 that may be equipped with advanced Layer 2 (L2) and Layer 3 (L3) processing capabilities, as well as a switch controller (SC) 226 and an out-of-band (OOB) communication interface 228. This configuration may enable the device 200 to perform enhanced network functions beyond traditional physical layer tasks, such as handling data routing, traffic prioritization, and dynamic control in network switching environments.

The device 200 extends the functionality of the basic PMD model described earlier by incorporating a Digital Signal Processor (DSP) with integrated L2, L3, and SC functionalities, labeled as 220. This integration enables the device 200 to handle both physical layer (Layer 1) tasks and higher network layers (Layers 2 and 3), which may typically have separate hardware in conventional systems. By integrating these functions directly at the PMD level, this design may allow the device 200 to respond to higher-layer protocols at the physical media layer, minimizing additional external switching and processing units and increasing the overall system's efficiency.

At the core of the PMD 210 may be the DSP with L2, L3, and SC functions 220, which may manage both physical and higher-layer data processing. This block may include elements for line-side data handling: the M×Line Rx 220a component, responsible for receiving and processing incoming data signals, and the M×Line Tx 220b component, responsible for preparing outgoing signals for transmission. Together, these blocks may allow the PMD 210 to efficiently manage data at the interface between physical media and higher-layer protocols, optimizing data flow from external network sources. Additionally, the M×ETx to M×M DSP xbar 220c and M×ERx connection to the M×M DSP xbar 220d may provide pathways for routing data from the line-side to the switch-side and vice versa, enabling flexible data movement within the network switch.

Transmit Photonics and Interface Circuits 212 and Receive Photonics and Interface Circuits 214 may facilitate the conversion between optical and electrical signals, supporting high-speed optical data transmission. Circuits 212, 214 may serve as the interface for data entering and exiting the PMD 210, allowing the device to connect to high-speed optical networks seamlessly. The DSP's 220 enhanced capabilities allow it to manage and route data at the L2 and L3 levels directly through these photonic interfaces, enabling efficient and robust data handling within complex networking environments.

Other supporting components, such as those indicated at unit 216, include a microcontroller unit (MCU) for system configuration and control, as well as circuitry for power management and regulation. These components ensure the stable and efficient operation of device 200, providing the DSP with the support to maintain high performance across its various data processing functions.

The L2 Stack 222 manages Layer 2 protocol operations, such as MAC address management, frame handling, and error checking, to enable reliable data transfers between directly connected nodes. With MAC address management, the DSP may handle packet forwarding based on destination MAC addresses, facilitating switching functions directly within the PMD 210. Additionally, frame handling and forwarding allow the PMD 210 to inspect and route frames with minimal latency by avoiding reliance on external switching devices. The error-checking mechanisms in the L2 stack, such as cyclic redundancy checks (CRC), ensure data integrity, enhancing reliability by detecting and responding to transmission errors at the data link layer.

The L3 Stack 224 in device 200 may be responsible for Layer 3 protocol functions, such as IP address routing and routing table management, which enable network-layer packet handling. This capability may reduce external routing hardware by allowing the PMD 210 to analyze packet headers and make routing decisions based on IP addresses and other network layer details. The L3 stack may also support Quality of Service (QoS) protocols, prioritizing data flows based on their importance, which may be useful in maintaining performance standards for latency-sensitive data, such as voice and video traffic.

The Switch Controller 226 may manage the device's operation within larger network configurations, enabling communication and synchronization with other PMDs and crossbars to optimize data routing and traffic flow. Through its control and synchronization functions, the Switch Controller 226 may coordinate with other components to avoid data loss or conflicts, dynamically adjusting resources and routing paths to accommodate changes in traffic demand. This feature may be valuable in high-density networks where bandwidth demands fluctuate frequently.

The Out-of-Band (OOB) Interface 228 may provide a dedicated communication channel separate from the main data paths, enabling control and management operations without disrupting primary data flow. This interface may allow network operators to monitor and configure the PMD remotely, access performance metrics, and perform diagnostics or firmware updates. By providing these capabilities outside of the main data channels, the OOB interface may ensure that the PMD remains functional and up-to-date without impacting normal data traffic.

Thus, the integration of the L2 Stack 222, L3 Stack 224, Switch Controller 226, and OOB Interface 228 within device 200 may enable a sophisticated data processing and management platform that supports advanced protocol handling, traffic prioritization, and network coordination. The DSP with L2, L3, and SC functions empowers the PMD to autonomously manage data flow within a network switch, reducing latency and enhancing performance. This architecture provides a scalable and flexible solution suitable for a wide range of applications, including data centers and telecommunications networks, where high-performance networking hardware is used for efficient data handling and reduced operational complexity.

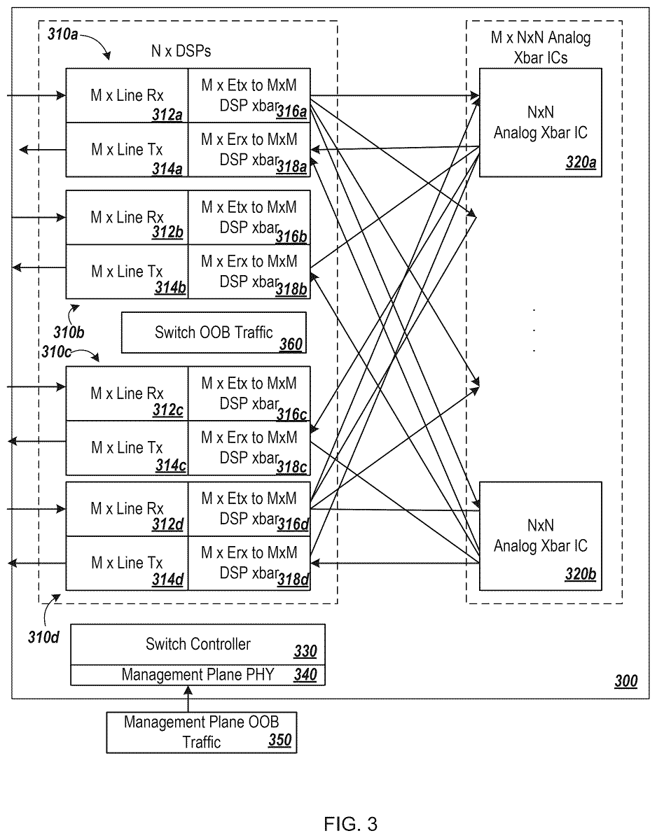

FIG. 3 illustrates an Analog Electrical Circuit Switch (AECS) system 300. System 300 includes a switch architecture that integrates multiple Physical Media Dependent (PMD) devices as shown in FIG. 2, each containing a Digital Signal Processor (DSP) (e.g., DSPs 310a, 310b, 310c, 310d) with advanced Layer 2 (L2) and Layer 3 (L3) processing capabilities as discussed above. This configuration enables highly efficient, low-latency communication, as well as dynamic crossbar control for optimized data flow within network environments. Each PMD device, exemplified by the DSP, incorporates line-side receivers (M×Line Rx 312a, 312b, 312c, 312d) that handle the reception of data packets from clients or upstream network sources, and line-side transmitters (M×Line Tx 314a, 314b, 314c, 314d) that manage transmission to downstream destinations or clients. Integrated within each DSP is an M×M DSP crossbar (Xbar) (e.g., M×ETx to M×M DSP xbar 316a, 316b, 316c, 316d and M×ERx to M×M DSP xbar 318a, 318b, 318c, 318d), which facilitates rapid data transfer between ports, ensuring efficient traffic flow throughout the AECS switch system 300. The DSP may include a Switch OOB (Out-of-Band) Traffic component 360, which may allow management and control traffic to operate independently from the primary data stream, optimizing latency-sensitive operations and handling advantageous control signals without interference.

The DSP within each PMD may play an advantageous role in Layer 2 and Layer 3 processing and crossbar control, performing real-time packet inspection at both levels by examining packet headers, including MAC addresses and IP addresses. PMDs may be configured to store and manage MAC address tables and IP routing tables, enabling immediate access to lookup information and facilitating efficient routing and switching decisions. The DSP may further control crossbars based on Layer 1, Layer 2, and Layer 3 requests, dynamically routing data packets through optimal paths in response to real-time network conditions and priority levels.

The AECS switch also incorporates a Switch Controller 330, which may coordinate the overall data flow within the network. This controller may resolve potential contention, manage resource allocation across the AECS switch, and communicate with each DSP via the Management Plane PHY 340 and OOB traffic channels. Through these communications, the Switch Controller 330 may dynamically update configuration parameters, including bandwidth allocation and priority settings, to adapt to changing network demands and ensure efficient traffic management.

Connected to the PMDs may be Analog Xbar ICs 320a, 320b configured in an N×N arrangement, providing additional routing flexibility across the switch. These crossbars may enable the AECS switch to maintain high-bandwidth, low-latency connections, as they can be reconfigured at multiple points in response to network requirements. By allowing for flexible data routing and optimized resource allocation, these Xbar ICs may contribute to the system's ability to handle complex networking scenarios.

Overall, the PMD devices, DSP-driven L2 and L3 processing, dynamic crossbar control, and switch management functionalities within the AECS switch enable a robust and scalable network infrastructure. This configuration may support high-speed, low-latency communication and adaptive network resource allocation, making it ideal for modern, data-intensive applications.

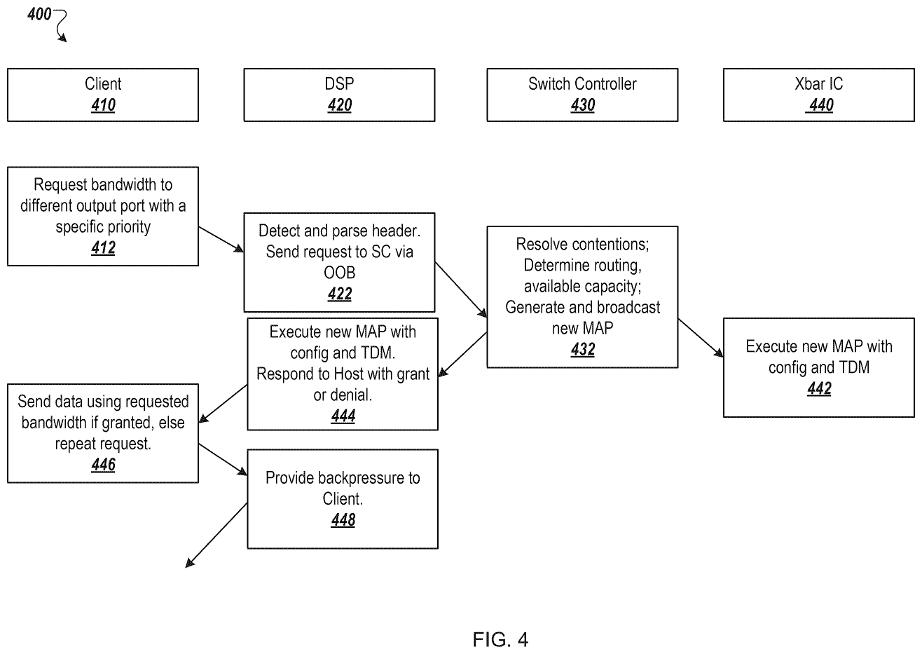

FIG. 4 depicts a process flow corresponding to the packet processing workflow within the AECS switch, focusing on the interactions between a client 410, the DSP 420 within a PMD, the Switch Controller 430, and the crossbar (Xbar) Integrated Circuit (IC) 440 components. In this configuration, a client may initiate a communication by requesting bandwidth to a specified output port, assigning a particular priority level to the request, as shown in block 312. This request may be received by the DSP 420, which may performs immediate header detection and parsing, leveraging its Layer 2 (L2) and Layer 3 (L3) processing capabilities, as shown in block 422. The DSP inspects both the MAC and IP headers to determine the appropriate routing decision, referencing stored MAC and IP tables as well as priority policies. Once the headers are parsed and the processing completed, the DSP 420 may generate a request to the Switch Controller 430 via the Out-of-Band (OOB) interface if additional resources or reconfiguration are used to fulfill the request efficiently.

The Switch Controller 430 may play an advantageous role in resource allocation within the AECS switch. Upon receiving a routing or bandwidth request from the DSP 420, the Switch Controller 430 evaluates the request, determines available resources, resolves any contention issues, and ensures that traffic flows efficiently across the switch infrastructure. To optimize data flow, the Switch Controller generates a new MAP (resource allocation map), which can incorporate time-division multiplexing (TDM) configurations if necessary, as shown in block 432. This MAP may be then broadcasted to DSPs and Xbar ICs involved in the network path, updating their configurations in real time to reflect the new resource allocation.

Following the MAP update from the Switch Controller, the Xbar ICs may execute the new configuration, as shown in block 442. This may involve adjusting the data paths in response to current network demands and conditions. The DSP 420, now equipped with the updated MAP, follows these instructions to direct traffic through the optimized network routes, as shown in block 444. This real-time coordination between the DSP, Switch Controller, and Xbar ICs reduces latency and improves data handling efficiency across the AECS switch.

In addition to handling traffic routing, the DSP 420 within the PMD may incorporate backpressure mechanisms to help regulate data flow. When congestion is detected, the DSP may generate backpressure signals that notify clients of current network constraints, prompting them to adjust data transmission rates to prevent data overflow, as shown in block 448. The DSP 420 may also apply dynamic traffic prioritization policies, ensuring that high-priority data receives minimal delay while lower-priority data may be queued if network resources are limited. This prioritization capability is advantageous in environments where time-sensitive data flows, such as voice or video, require immediate processing to maintain quality of service.

By enabling intelligent packet inspection, dynamic resource allocation, and adaptive traffic management, FIG. 4 demonstrates how the AECS switch leverages DSP-driven PMD devices and crossbar coordination to provide an efficient, low-latency networking solution. This design is well-suited for data centers, telecommunication networks, and other high-density environments where flexible and responsive packet handling is essential for maintaining network performance and scalability.

By employing these advanced DSP-driven functionalities, the AECS switch achieves an optimized network infrastructure capable of handling high-speed, low-latency communications with enhanced control over network resource allocation. This architecture significantly improves performance, allowing for scalable and adaptive networking solutions suitable for modern data-intensive applications.

The operations provided in FIG. 4 may be performed globally (e.g., on a network node) and may use e.g., segment routing over IPv6 dataplane (SRV6) technology and/or software-defined networking (SDN). An SDN controller may request bandwidth and receive allocation. Using SDN may provide a global view of congestion so that routing may be performed more efficiently.

AECS system 300's switch configuration may incorporate a DSP with advanced L2 and L3 protocol processing capabilities, enabling more refined Quality of Service (QoS) management within the network. The DSP may integrate a QoS policy engine within its L3 stack, allowing it to prioritize data packets based on predefined or dynamic service levels. This capability may enable the system to allocate network resources efficiently, ensuring that high-priority traffic, such as real-time voice or video data, is processed with reduced latency and higher bandwidth allocation. By monitoring packet priority levels within the DSP's L3 stack, the AECS switch may dynamically adjust crossbar configurations and resource allocation maps, directing advantageous data flows along optimal paths and guaranteeing the required service quality. This level of QoS management within the DSP may enhance performance consistency across the network, supporting mission-advantageous applications that depend on stable and predictable data throughput.

To further enhance QoS, the DSP may be configured to apply traffic-shaping techniques that include packet queuing, bandwidth throttling, and dynamic allocation adjustments based on real-time network load conditions. When the DSP detects congestion or high traffic load through its continuous inspection of data flows, it may proactively adjust lower-priority traffic, either by rerouting it to less congested paths within the crossbars or by temporarily buffering it. This approach may prevent lower-priority traffic from interfering with high-priority data transmission, maintaining efficient network utilization while upholding the QoS requirements of priority traffic.

In addition to QoS functionality, the DSP's L2 stack incorporates comprehensive error-checking mechanisms to enhance data integrity. The DSP's L2 stack may be equipped with error-detection protocols, such as Cyclic Redundancy Check (CRC), which may verify the integrity of each incoming frame before forwarding it to the L3 processing layer. If the DSP detects an error in the data frame during the CRC verification process, it may initiate corrective actions, such as requesting retransmission from the source or discarding the corrupted frame to prevent propagation of erroneous data across the network. This error-checking mechanism may ensure that only verified, error-free data is processed and routed within the network, thereby enhancing overall reliability and reducing the likelihood of data corruption in transit.

For further accuracy, the DSP's error-checking functionality may be integrated with the switch controller's resource allocation and management operations as depicted in FIG. 4. When the switch controller detects repeated errors or link instability based on reports from multiple DSPs within the AECS switch, it may dynamically adjust routing paths or resource allocation to bypass problematic links or nodes, minimizing the impact on overall network performance. Additionally, the DSP may flag persistent error conditions to the switch controller through out-of-band communication, triggering diagnostics or maintenance alerts to address the underlying issue.

These expanded QoS and error-checking capabilities within the DSP not only enhance network resilience but also enable the AECS switch to support higher service levels across complex, high-density data environments. By embedding these functions directly within the PMD's DSP layer, the AECS switch achieves a high degree of flexibility and responsiveness, delivering an optimized balance of speed, reliability, and service quality for a broad range of network applications.

Switch 200, 300 components (not shown) may include a number of processing units and/or CPUs. Use in any application involving processors and/or software: One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” (or “computer readable medium”) refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” (or “computer readable signal”) refers to any signal used to provide non-transitory machine readable instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

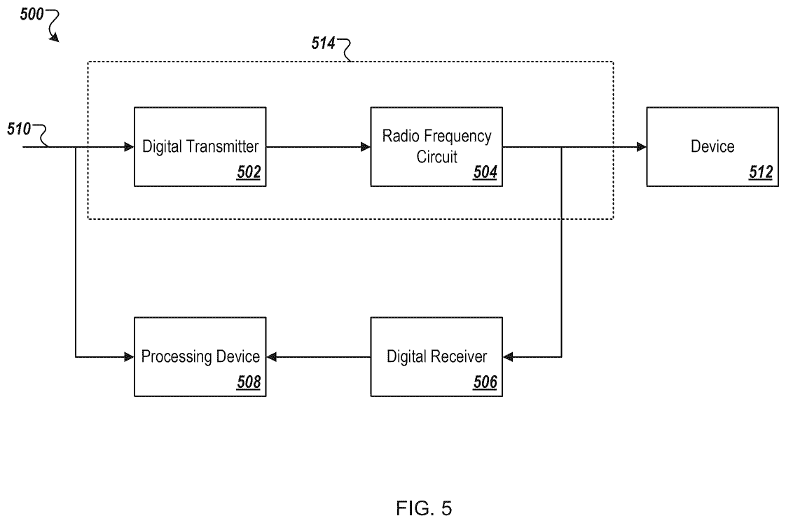

For example, FIG. 5 illustrates a block diagram of an example communication system 500 configured for implementing one or more of the embodiments described above. In some embodiments, a communication system 500 may include a digital transmitter 502, a radio frequency circuit 504, a device 512, a digital receiver 506, and a processing device 508. The digital transmitter 502 and the processing device may be configured to receive a baseband signal via connection 510. A transceiver 514 may comprise the digital transmitter 502 and the radio frequency circuit 504.

In some embodiments, the communication system 500 may include a system of devices that may be configured to communicate with one another via a wired or wireline connection. For example, a wired connection in the communication system 500 may include one or more Ethernet cables, one or more fiber-optic cables, and/or other similar wired communication mediums. Alternatively, or additionally, the communication system 500 may include a system of devices that may be configured to communicate via one or more wireless connections. For example, the communication system 500 may include one or more devices configured to transmit and/or receive radio waves, microwaves, ultrasonic waves, optical waves, electromagnetic induction, and/or similar wireless communications. Alternatively, or additionally, the communication system 500 may include combinations of wireless and/or wired connections. In some embodiments, the communication system 500 may include one or more devices that may obtain a baseband signal, perform one or more operations to the baseband signal to generate a modified baseband signal, and transmit the modified baseband signal, such as to one or more loads.

In some embodiments, the communication system 500 may include one or more communication channels that may communicatively couple systems and/or devices included in the communication system 500. For example, the transceiver 514 may be communicatively coupled to the device 512.

In some embodiments, the transceiver 514 may be configured to obtain a baseband signal. For example, as described herein, the transceiver 514 may be configured to generate a baseband signal and/or receive a baseband signal from another device. In some examples, the transceiver 514 may be configured to transmit the baseband signal. For example, upon obtaining the baseband signal, the transceiver 514 may be configured to transmit the baseband signal to a separate device, such as the device 512. Alternatively, or additionally, the transceiver 514 may be configured to modify, condition, and/or transform the baseband signal in advance of transmitting the baseband signal. For example, the transceiver 514 may include a quadrature up-converter and/or a digital to analog converter (DAC) that may be configured to modify the baseband signal. Alternatively, or additionally, the transceiver 514 may include a direct radio frequency (RF) sampling converter that may be configured to modify the baseband signal.

In some embodiments, the digital transmitter 502 may be configured to obtain a baseband signal via connection 510. In some examples, the digital transmitter 502 may be configured to up-convert the baseband signal. For example, the digital transmitter 502 may include a quadrature up-converter to apply to the baseband signal. In some examples, the digital transmitter 502 may include an integrated digital to analog converter (DAC). The DAC may convert the baseband signal to an analog signal, or a continuous time signal. In some examples, the DAC architecture may include a direct RF sampling DAC. In some examples, the DAC may be a separate element from the digital transmitter 502.

In some embodiments, the transceiver 514 may include one or more subcomponents that may be used in preparing the baseband signal and/or transmitting the baseband signal. For example, the transceiver 514 may include an RF front end (e.g., in a wireless environment) which may include a power amplifier (PA), a digital transmitter (e.g., 502), a digital front end, an Institute of Electrical and Electronics Engineers (IEEE) 1588v2 device, a Long-Term Evolution (LTE) physical layer (L-PHY), an (S-plane) device, a management plane (M-plane) device, an Ethernet media access control (MAC)/personal communications service (PCS), a resource controller/scheduler, and the like. In some examples, a radio (e.g., a radio frequency circuit 504) of the transceiver 514 may be synchronized with the resource controller via the S-plane device, which may contribute to high-accuracy timing with respect to a reference clock.

In some embodiments, the transceiver 514 may be configured to obtain the baseband signal for transmission. For example, the transceiver 514 may receive the baseband signal from a separate device, such as a signal generator. For example, the baseband signal may come from a transducer configured to convert a variable into an electrical signal, such as an audio signal output of a microphone picking up a speaker's voice. Alternatively, or additionally, the transceiver 514 may be configured to generate a baseband signal for transmission. In these and other examples, the transceiver 514 may be configured to transmit the baseband signal to another device, such as the device 512.

In some embodiments, the device 512 may be configured to receive a transmission from the transceiver 514. For example, the transceiver 514 may be configured to transmit a baseband signal to the device 512. In some embodiments, the radio frequency circuit 504 may be configured to transmit the digital signal received from the digital transmitter 502. In some examples, the radio frequency circuit 504 may be configured to transmit the digital signal to the device 512 and/or the digital receiver 506. In some examples, the digital receiver 506 may be configured to receive a digital signal from the RF circuit and/or send a digital signal to the processing device 508.

In some embodiments, the processing device 508 may be a standalone device or system, as illustrated. Alternatively, or additionally, the processing device 508 may be a component of another device and/or system. For example, in some examples, the processing device 508 may be included in the transceiver 514. In instances in which the processing device 508 is a standalone device or system, the processing device 508 may be configured to communicate with additional devices and/or systems remote from the processing device 508, such as the transceiver 514 and/or the device 512. For example, the processing device 508 may be configured to send and/or receive transmissions from the transceiver 514 and/or the device 512. In some examples, the processing device 508 may be combined with other elements of the communication system 500.

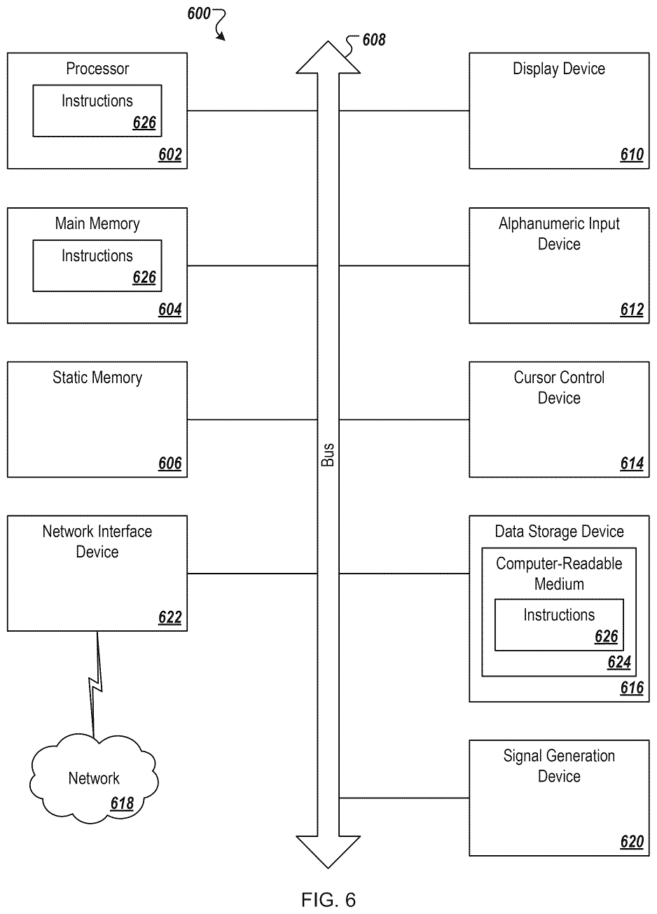

Referring now to FIG. 6 illustrates a diagrammatic representation of a machine in the example form of a computing device 600 within which a set of instructions, for causing the machine to perform any one or more of the methods discussed herein, may be executed. The computing device 600 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a local area network (LAN), an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

In some embodiments, device 600 includes a processing device (e.g., a processor) 602, a main memory 604 (e.g., read-only memory (ROM), flash memory, dynamic random access memory (DRAM) such as synchronous DRAM (SDRAM)), a static memory 606 (e.g., flash memory, static random access memory (SRAM)) and a data storage device 616, which communicate with each other via a bus 608.

In some embodiments, processing device 602 represents one or more general-purpose processing devices such as a microprocessor, central processing unit, or the like. More particularly, the processing device 602 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 602 may also include one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein.

The computing device 600 may further include a network interface device 622 which may communicate with a network 618. The computing device 600 also may include a display device 610 (e.g., a liquid crystal display (LCD) or a cathode ray tube (CRT)), an alphanumeric input device 612 (e.g., a keyboard), a cursor control device 614 (e.g., a mouse) and a signal generation device 620 (e.g., a speaker). In at least one example, the display device 610, the alphanumeric input device 612, and the cursor control device 614 may be combined into a single component or device (e.g., an LCD touch screen).

The data storage device 616 may include a computer-readable storage medium 624 on which is stored one or more sets of instructions 626 embodying any one or more of the methods or functions described herein. The instructions 626 may also reside, completely or at least partially, within the main memory 604 and/or within the processing device 602 during execution thereof by the computing device 600, the main memory 604 and the processing device 602 also constituting computer-readable media. The instructions may further be transmitted or received over a network 618 via the network interface device 622.

While the computer-readable storage medium 624 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

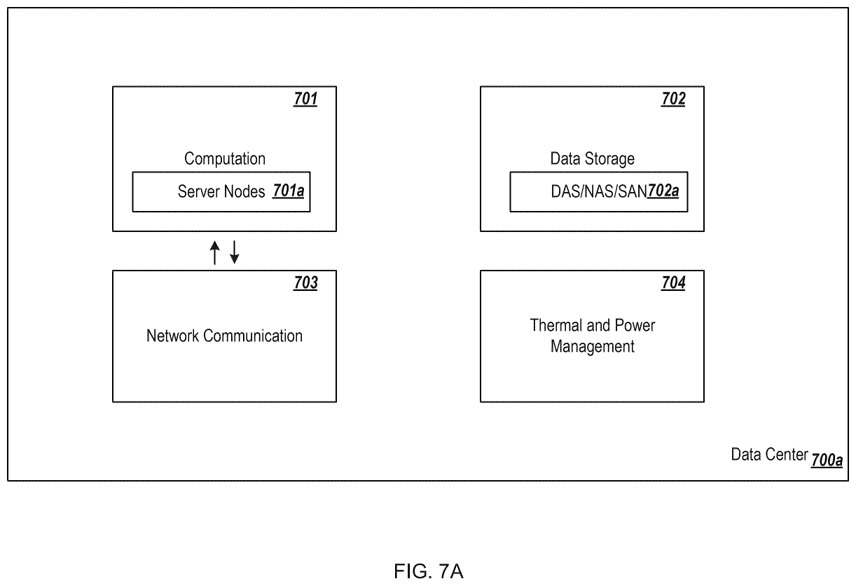

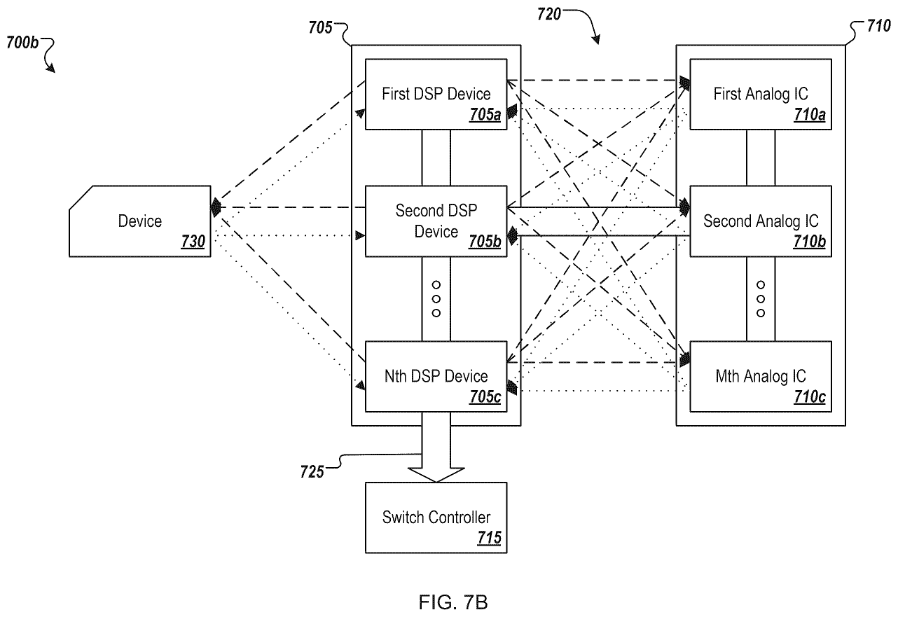

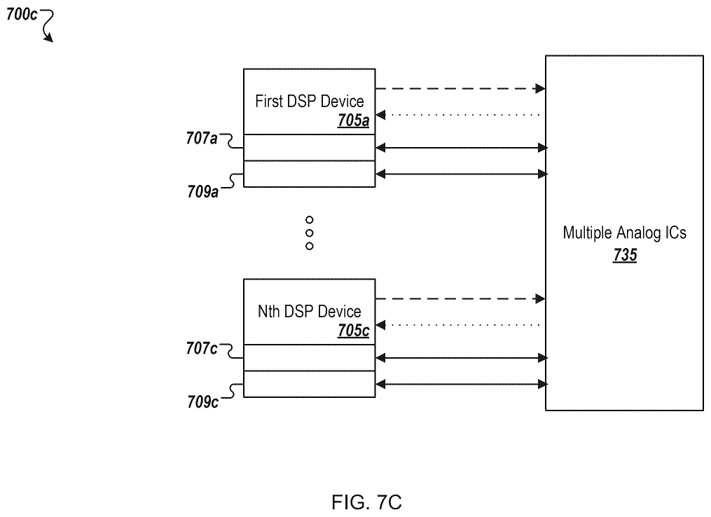

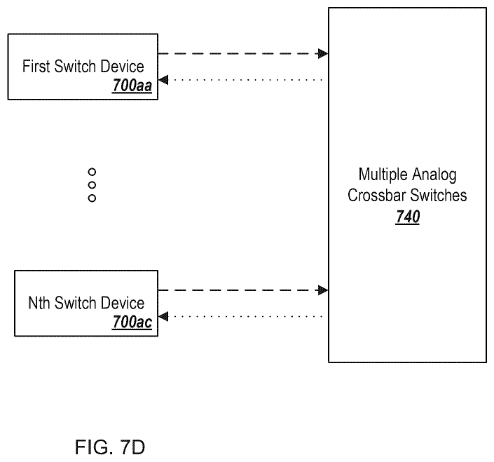

As illustrated in FIG. 7, a block diagram of a data center 700a may include multiple subsystems configured to perform various operational functions, including computation 701, data storage 702, network communication 703, and thermal and power management 704. The computation 701 subsystem may include one or more server nodes 701a that may execute software applications and process data workloads. The data storage 702 subsystem may provide persistent data retention through devices such as hard disk drives, solid-state drives, or distributed storage arrays, which may be organized in configurations such as Direct Attached Storage (DAS), Network Attached Storage (NAS), or Storage Area Networks (SAN) 702a. The networking communication 703 subsystem may facilitate bidirectional data transfer between servers and external networks through high-speed switching and routing components. The thermal and power management 704 subsystem may maintain operational integrity by regulating temperature and supplying uninterrupted electrical power, e.g., through redundant power sources and cooling mechanisms. Each subsystem may operate in coordination to ensure continuous availability, scalability, and fault tolerance and the ability to scale up and scale out in response to increasing computational and storage demands.

The architecture of a data center 700a may include multiple physical and logical components that collectively enable high-performance computing and data handling. The compute layer may include server racks populated with processors optimized for general-purpose or specialized workloads, including central processing units (CPUs), graphics processing units (GPUs), and field-programmable gate arrays (FPGAs). The storage layer may incorporate hierarchical storage systems that may employ high-speed interfaces such as Non-Volatile Memory Express (NVMe) to reduce latency. The networking layer may use top-of-rack switches, aggregation switches, and core routers arranged in various topologies, (e.g., crossbar, Clos, leaf-spine, etc.) to provide non-blocking connectivity and minimize hop count between endpoints. Power distribution units (PDUs), uninterruptible power supplies (UPS), and backup generators may form the electrical infrastructure, while cooling systems may employ air-based or liquid-based heat dissipation techniques to maintain thermal stability. These components may be integrated to achieve high reliability, modular scalability, and compliance with performance requirements, enabling the system to scale up and scale out as operational loads increase.

In operation, a data center may process client requests through a multi-stage workflow that includes traffic distribution, application execution, and data retrieval. Incoming requests may be received by a load balancing system configured to allocate workloads across multiple compute nodes to prevent resource saturation. Application servers may execute the requested operations, which may involve accessing structured or unstructured data stored within the storage subsystem. Virtualization technologies may enable multiple virtual machines to operate on a single physical server, thereby optimizing resource utilization. Containerization frameworks, such as those implementing Linux containers, may provide isolated execution environments for microservices and facilitate rapid deployment across heterogeneous hardware. The networking subsystem may ensure deterministic packet routing and congestion management through high-speed interconnects and software-defined networking protocols. This operational workflow may be designed to maintain low latency, high throughput, and fault-tolerant performance under variable load conditions, while supporting the ability to scale up and scale out dynamically.

Conventional data center implementations may exhibit several advancements aimed at improving efficiency, scalability, and sustainability. Hyperscale architectures may employ large-scale server clusters interconnected through high-bandwidth fabrics to support cloud computing and artificial intelligence workloads. Edge computing deployments may position micro data centers proximate to end-user devices to reduce network latency and enable real-time processing. Specialized accelerators, including GPUs and tensor processing units (TPUs), may be increasingly integrated to support machine learning and high-performance computing applications. Energy efficiency initiatives may incorporate renewable energy sources and advanced cooling methodologies, such as liquid immersion cooling, to reduce operational costs and environmental impact. These trends reflect an industry-wide transition toward architectures that may be highly distributed, workload-optimized, and environmentally sustainable.

A scale-up network architecture may be characterized by the addition of resources within a single network node or chassis to increase capacity. In such configurations, performance improvements may be achieved by augmenting the processing capability, memory, or port density of an existing switch or router. This approach may involve deploying high-capacity modular switches with vertically integrated backplanes and high-bandwidth switch fabrics. The scale-up model may be advantageous for environments having centralized control and minimal inter-node latency, as all traffic may be processed within a single logical device.

A scale-out network architecture may be characterized by the horizontal expansion of network capacity through the addition of multiple interconnected nodes. In this configuration, performance and scalability may be achieved by distributing workloads across multiple switches, for example arranged as a leaf-spine architecture. Each leaf switch may provide connectivity to compute and storage resources, while spine switches interconnect the leaf layer to form a non-blocking, high-bandwidth fabric. The scale-out model may enable incremental capacity expansion without completely replacing existing infrastructure, thereby supporting elastic growth and fault tolerance. This architecture may be particularly suited for large-scale data centers and cloud environments, where traffic patterns may be highly distributed and use predictable bandwidth. Scale-out networks may leverage parallelism and redundancy to achieve near-linear scalability.

A scale-up network may carry information, including AI training and inference algorithms, among computing units (such as graphics processing units (GPUs)). These networks may have various characteristics such as high bandwidth (e.g., non-blocking all-to-all bandwidth), low latency (e.g., minimize layers of switching and per-switch latency), and scalability (e.g., supporting high numbers of interconnected GPUs and low energy per bit transferred through network). For purposes of this disclosure, a “GPU” has been provided as an example and instances of GPU may be substituted by any type of processor such as CPUs, ASICs, or the like.

Conventional scale-up networks may centralize the switching/routing function in order to scale GPU connectivity across multiple rack units and even multiple racks. An example compute rack may include 18 compute trays consuming about 6 kW each, and 9 switch trays consuming about 1 kW each. Each GPU may have 18 ports of 100 GB/s each (or 1.8 TB/s per GPU), and the rack network (which may be implemented using a copper backplane) may connect each GPU to the 9 switch trays to provide each GPU with the ability to deliver all of its 1.8 TB/s to any other GPU in the rack, a capability often referred to as “All-to-All bandwidth”. This may be used for parallelizing the computation of an AI model for training or inference purposes.

This rack-level power density may be quite high and push the limit of electrical power and thermal cooling densities, leaving little room for additional compute trays. Furthermore, switch connectivity for all-to-all crossbar-like functionality has complexity and power which may vary quadratically with the number of ports being interconnected, so scaling the GPUs connected within a rack may be constrained, even when the number of GPUs may be increased.

A centralized full crossbar may be replaced with distributed crossbars which places ultra-efficient, ultra-low-latency analog crossbars locally with their respective GPUs, and routes them to digital switch SOCs with an arrangement of crossbars which may be simplified compared with full crossbars. This may drive improvements in network power, latency, complexity, and scalability.

As a result, network traffic (e.g., which may be AI traffic) may be matched with low predictable latency providing all-to-all bandwidth. Compared to Ethernet packet switches, ⅕ of the power may be consumed. The device may be capable of high radix implementations (e.g., 1024 lanes). The device may be usable in all-copper backplane scale ups as well as with multi-mode (MM) fiber.

Thus, the examples described herein present systems and methods for an Analog Electrical Circuit Switch (AECS) switch capable of ultra-low-latency (e.g., <5 ns, 10 ns, or the like) and low-power switching across a flexible any-to-any crossbar architecture. The AECS switch eliminates internal buffering and packet inspection within the crossbar, allowing for a highly efficient and scalable architecture. A programmable crossbar configuration may dynamically map input ports to output ports in response to real-time traffic conditions.

An example system may include advanced control mechanisms for broadcasting and multicasting data from a single input to multiple outputs, optimizing resource allocation and minimizing overhead. Make-before-break (MBB) protocols may be employed to ensure seamless reconfiguration of crossbar connections without data loss, even during high-speed operations. Additionally, adaptive equalization techniques may be integrated into the system, allowing the AECS to optimize signal quality based on feedback from connected devices.

An architecture may include redundancies along with digital signal processors (DSPs) configured to support any-to-any connections. In such an arrangement, low-latency switching along with low power use per lane may be achieved. Further, memory included in the DSPs may be used for any storage or buffering and each of the components included in the switch may include redundant lanes such that degradations or broken DSPs may be rerouted around and replaced without losses to the system. The reconfiguration in the switch may be dynamically performed (e.g., such as in view of real-time traffic managed by the switch) by a switch controller that may communicate with the components in the switch using out-of-band traffic so as to not interfere with the in-band communications otherwise being handled by the switch.

FIG. 7B illustrates an example switch device 700b. The switch device 700b may include a first digital signal processor (DSP) device 705a, a second DSP device 705b, an nth DSP device 705c, referred to collectively as multiple first electronic devices 705, a first analog integrated circuit (IC) 710a, a second analog IC 710b, an mth analog IC 710c, referred to collectively as multiple second electronic devices 710, a switch controller 715, in-band traffic 720, and out-of-band traffic 725. First DSP 705a, second DSP 705b, and nth DSP 705c may have input and output as shown in greater detail with respect to FIG. 2.

The switch device 700b may be reconfigurable (e.g., in terms of the connections between the components therein, such as the multiple first electronic devices 705 and the multiple second electronic devices 710, the switch controller 715, and/or a device 730), where the switching of the connections/lanes between the components may be low latency (e.g., less than 5 ns, 10 ns, or the like switching). Alternatively, or additionally, the switch device 700b may reconfigure without the use of retiming such that each lane of the multiple lanes included therein may use less than 50 mW of power. For example, each lane of the multiple lanes may support 100G bandwidth while using less than 50 mW of power.

The multiple first electronic devices 705 may individually include one or more ports that may be used to facilitate communications within the switch device 700b, such as between the multiple first electronic devices 705 and the multiple second electronic devices 710, the switch controller 715, and/or a device 730. The communications in the switch device 700b may be transmitted via multiple lanes in the switch device 700b. The multiple lanes may facilitate the in-band traffic 720 and/or the out-of-band traffic 725.

The multiple lanes between the multiple first electronic devices 705 and the multiple second electronic devices 710 may be in an any-to-any configuration. For example, the first DSP device 705a may include a lane to the first analog IC 710a, to the second analog IC 710b, and/or the mth analog IC 710c. A similar arrangement may occur for each of the multiple first electronic devices 705, such that each DSP device of the multiple first electronic devices 705 may include a lane to any number of the multiple second electronic devices 710, including none of the multiple second electronic devices 710. As illustrated in FIG. 7, each lane for facilitating the in-band traffic 720 may be in both directions (e.g., transmit and receive) between the multiple first electronic devices 705, the multiple second electronic devices 710, and/or a device 730. Alternatively, or additionally, the lanes are dashed/dotted to illustrate that for any transmit/receive path between the multiple first electronic devices 705, the multiple second electronic devices 710, and/or a device 730, a lane may or may not be present.

The multiple first electronic devices 705, the multiple second electronic devices 710, and/or the switch controller 715 may be disposed on a printed circuit board (PCB) where traces on the PCB may be used to connect at least the multiple first electronic devices 705, the multiple second electronic devices 710, and/or the switch controller 715 (e.g., the traces on the PCB may facilitate the in-band traffic 720 and/or the out-of-band traffic 725 in the switch device 700b). Alternatively, or additionally, the multiple first electronic devices 705, the multiple second electronic devices 710, and/or the switch controller 715 may be connected to one another using connectors, such as high-speed cables, where the multiple first electronic devices 705, the multiple second electronic devices 710, and/or the switch controller 715 may individually include ports/headers to support the use of the connectors. In instances in which the connectors are used, crosstalk between the multiple lanes in the switch device 700b may be reduced relative to the crosstalk that may occur when the switch device 700b uses traces on a PCB.

The switch device 700b, including the multiple first electronic devices 705, the multiple second electronic devices 710, and/or the switch controller 715, may be utilized with one or more additional switches and/or crossbar devices to form a new crossbar switch device, which may be larger than any one of the switch devices 700b. For example, as illustrated and discussed relative to FIG. 7C, the switch device 700b may be utilized with any other number of switch devices 700b (e.g., the nth switch device 700ac in FIG. 7C) and multiple analog crossbar switches 740 to form a new crossbar switch device.

The multiple first electronic devices 705 may be digital signal processors (DSPs) and/or the multiple second electronic devices 710 may be analog circuit switch integrated circuits (ICs) for use with electrical signals. Alternatively, or additionally the multiple second electronic devices 710 may be analog optical circuit switch ICs for use with optical signals. The multiple first electronic devices 705 may be individually configured to support one or more layer of the open systems interconnection (OSI) model. For example, each of the multiple first electronic devices 705 may be configured to support layer 1 protocols, layer 2 protocols, and/or layer 3 protocols with respect to the in-band traffic 720 and/or the out-of-band traffic 725.

Each, or at least one, of the multiple first electronic devices 705 may support layer 1 protocols, which may include detecting and/or processing layer 2 protocols and/or layer 3 protocols, handling layer 2 protocol and/or layer 3 protocol addressability, frame header detection, packet header inspection, responding to layer 2 protocol and/or layer 3 protocol requests, storing information in response to a request associated with layer 2 protocols and/or layer 3 protocols, updating information in response to a request associated with layer 2 protocols and/or layer 3 protocols, communicating information in response to a request associated with layer 2 protocols and/or layer 3 protocols, optimizing information in response to a request associated with layer 2 protocols and/or layer 3 protocols, etc. Each of the multiple first electronic devices 705 may be able to adjust the way in which traffic is directed through it, such as in response to a command from the switch controller 715. For example, each of the multiple first electronic devices 705 may be operable to configure an internal switch, an external switch, or a crossbar based on the various layer protocol processing to be performed.

The first DSP device 705a may receive a communication that includes a frame header (or a packet header) and the first DSP device 705a may be configured to detect the frame header and decode the frame header along with any associated contents of the communication, all within the first DSP device 705a. In a second example, the first DSP device 705a may integrate a media access control (MAC) address lookup table which may allow the first DSP device 705a to configure one or more crossbars such that the first DSP device 705a may facilitate connectivity between any two MAC addresses that are included in the lookup table. Alternatively, or additionally, each of the first electronic devices 705 may include a lookup table that may store equalization settings that may be used for various connections between the first electronic devices 705 and other components within the switch device 700b. The equalization settings in the lookup table may be used to accelerate acquisition and/or tracking for a particular DSP device of the multiple first electronic devices 705 when the particular DSP device switches connections within the switch device 700b.

The multiple first electronic devices 705 may be configured to respond to layer 2 protocol requests and/or layer 3 protocol requests for connectivity and/or resource grant requests. For example, the multiple first electronic devices 705 may compare a request to a lookup table that includes priority levels and the multiple first electronic devices 705 may be operable to configure themselves and/or associated crossbars and/or switches based on the determined priority level. Alternatively, or additionally, each of the multiple first electronic devices 705 may be configured to respond to in-band requests (e.g., granting a connection request, signaling backpressure to the device 730, etc.), collect statistics on traffic handled by the multiple first electronic devices 705 (e.g., link utilization and/or traffic type), and/or perform data filtering (e.g., detecting a particular header, performing routing, generating flags and/or interrupts, and/or logging any of the filtering events).

The multiple first electronic devices 705 may be configured to communicate with (e.g., transmit data to and/or receive data from) the device 730. The communication with the device 730 may include in-band traffic 720. In such instances, the communications between the multiple first electronic devices 705 and the device 730 may be line-side communications, where the lines may facilitate communications using various communication channels. For example, the line-side communications between the multiple first electronic devices 705 and the device 730 may be an electrical-to-electrical connection, an optical-to-optical connection, an electrical-to-optical connection, or an optical-to-electrical connection, and so forth.

The device 730 may address communications directly to one of the multiple first electronic devices 705. For example, the device 730 may address communications to the second DSP device 705b. Alternatively, or additionally, the device 730 may address communications to the switch controller 715, which may then direct communications to the appropriate DSP device. For example, the device 730 may address communications intended for the second DSP device 705b to the switch controller 715 and the switch controller 715 may direct the communications to the second DSP device 705b.

The multiple first electronic devices 705 may individually include memory that may be used as a buffer for communications through the multiple first electronic devices 705. The memory in the multiple first electronic devices 705 may be utilized to buffer incoming and/or outgoing traffic, which may include in-band traffic 720 and/or out-of-band traffic 725. Due to the memory in the multiple first electronic devices 705 being distributed (e.g., by the distributed nature of the multiple first electronic devices 705), the switch device 700b may not include any memory for buffering in addition to the memory included in the multiple first electronic devices 705.

The multiple first electronic devices 705 may individually include one or more additional lanes that may be used for communications in the switch device 700b. Further details associated with the additional lanes are included in the description associated with FIG. 7C.

The multiple second electronic devices 710 may individually include one or more ports that may be used to facilitate communications within the switch device 700b, similar to the ports described relative to the multiple first electronic devices 705. Alternatively, or additionally, the lanes for communications between the multiple first electronic devices 705 and the multiple second electronic devices 710 may be coupled with the ports included in the multiple second electronic devices 710.

The switch controller 715 may be a microcontroller unit (MCU). Alternatively, or additionally, the switch controller 715 may be a DSP, or other processing device. The switch controller 715 may be communicatively coupled with at least the multiple first electronic devices 705 and/or the multiple second electronic devices 710. The switch controller 715 may resolve resource grant requests, distribute the network state to the multiple first electronic devices 705 and/or to the multiple second electronic device 710, and/or may establish and/or maintain timing among the components included in the switch device 700b.

The switch controller 715 may communicate with the multiple first electronic devices 705 and/or the multiple second electronic devices 710 using a separate connection/lane than the connections between the multiple first electronic devices 705 and the multiple second electronic devices 710. For example, the first connection between the multiple first electronic devices 705 and the multiple second electronic devices 710 may facilitate the in-band traffic 720 and the second connection between the switch controller 715 and the multiple first electronic devices 705 and/or the multiple second electronic devices 710 may facilitate the out-of-band traffic 725.

The out-of-band traffic 725 may use a different network than the in-band traffic 720. Alternatively, or additionally, the out-of-band traffic 725 may use a different physical layer protocol than the in-band traffic 720. The out-of-band traffic 725 may be used to manage and/or configure one or more components included in the switch device 700b. For example, the switch controller 715 may communicate with the multiple first electronic devices 705 using the out-of-band traffic 725 to reconfigure lanes and/or traffic routing based on the traffic through the switch device 700b.

The switch controller 715 may be programmable such that the switch controller 715 may be operable to dynamically map the lanes between the multiple first electronic devices 705 and the multiple second electronic devices 710. For example, in instances in which the first DSP device 705a includes a lane to the first analog IC 710a, the switch controller 715 may dynamically map the lane to be from the first DSP device 705a to the second analog IC 710b. The switch controller 715 may dynamically adapt the mapping of the lanes between the multiple first electronic devices 705 and the multiple second electronic devices 710 based on one or more conditions and/or a satisfaction of a threshold related to the conditions. For example, in instances in which the real-time data traffic in the switch device 700b (or an amount of real-time data traffic handled by one of the multiple first electronic devices 705 and/or one of the multiple second electronic devices 710) satisfies a threshold, the switch controller 715 may dynamically adapt the mapping of the lanes as described.

The switch device 700b may include one or more redundant lanes that may be used in various situations during operation of the switch device 700b. For example, one or more redundant lanes may be used for the out-of-band traffic 725, such as signaling using the out-of-band traffic 725. In such instances, the out-of-band signaling may be transmitted and/or received by a particular DSP device and/or by the switch controller 715, and the out-of-band signaling may be a lower transmission rate than the in-band traffic 720. In another example, one or more redundant lanes may be used for out-of-bandwidth broadcasts from the switch controller 715 and/or from one or more of the multiple first electronic devices 705 to other devices in the switch device 700b (e.g., such as other DSP devices).

The switch controller 715 may reserve a portion of bandwidth associated with the in-band traffic 720 in the switch device 700b. The bandwidth reserved by the switch controller 715 may be reserved on a per lane basis of the multiple lanes included in the switch device 700b. For example, a first lane between the first DSP device 705a and the first analog IC 710a may have a first reserved bandwidth and a second lane between the second DSP device 705b and the second analog IC 710b may have a second reserved bandwidth, where the amount of bandwidth reserved may be the same or may differ between the first reserved bandwidth and the second reserved bandwidth. The switch controller 715 may allocate resources within the switch device 700b based on predicted or anticipated traffic (e.g., based on a probabilistic model).

Alternatively, or additionally, the switch controller 715 may monitor the lanes of the multiple lanes in the switch device 700b. The switch controller 715 may monitor the multiple lanes periodically and/or in a round robin manner, such that the lanes of the multiple lanes may observed to determine if failures or degradations may be present in a lane. In instances in which a lane experiences a degradation that satisfies a threshold for an acceptable loss, the switch controller 715 may dynamically remap a new lane in the switch device 700b to replace the degraded lane.

The switch controller 715 may perform adaptive signal equalization to the in-band traffic 720 in the switch device 700b. For example, the multiple first electronic devices 705 may provide feedback to the switch controller 715 relative to the workload handled by the multiple first electronic devices 705, and the switch controller 715 may adaptively manage workloads of the multiple first electronic devices 705 to optimize performance of the switch device 700b.

A backup switch controller (not illustrated) may be included in the switch device 700b. The backup switch controller may be a redundant controller relative to the switch controller 715. The backup switch controller may include the same or similar connections as the switch controller 715 relative to the multiple first electronic devices 705 and/or the multiple second electronic devices 710. The backup switch controller may perform the same or similar operations as the switch controller 715.

FIG. 7C illustrates an example switch device 700c. The switch device 700c may include a first DSP device 705a, an nth DSP device 705c, and multiple analog ICs 735. The first DSP device 705a may include a first auxiliary channel 707a, and a first out-of-band channel 709a. The nth DSP device 705c may include an nth auxiliary channel 707c, and an nth out-of-band channel 709c.

The first DSP device 705a, the nth DSP device 705c, and the multiple analog ICs 735 may be the same or similar as the first DSP device 705a, the nth DSP device 705c, and the multiple second electronic devices 710, respectively, of FIG. 7A and may be operable to perform the same or similar functions as described.

The auxiliary channels 707 (e.g., the first auxiliary channel 707a and the second auxiliary channel 707c) may be individually utilized by each of the DSP devices 705a, 705c as an additional lane for in-band traffic between at least the DSP devices 705a, 705c and the multiple analog ICs 735. The auxiliary channels 707 may be used to redundantly transmit in-band traffic relative to another lane included in the DSP devices 705a, 705c prior to a change in configuration to the corresponding DSP devices 705a, 705c. For example, in instances in which the first DSP device 705a includes a lane to a particular analog IC of the multiple analog ICs 735 and the first DSP device 705a is to be reconfigured (e.g., by a switch controller as described herein), the first auxiliary channel 707a may have a lane mapped to the particular analog IC such that the in-band traffic is redundant between the first DSP device 705a and the particular analog IC prior to reconfiguring the lanes associated with the first DSP device 705a (which reconfiguration may otherwise break the connection between the first DSP device 705a and the particular analog IC).

The auxiliary channels 707 may be used for communication between other near DSP devices. For example, in instances in which the first DSP device 705a is disposed spatially near to the nth DSP device 705c, the first DSP device 705a and the nth DSP device 705c may communicate with one another via the auxiliary channels 707. Such communications may be possible as the channels between near-neighbors may be relatively clean, such that physical layer processing may be simplified and may result in power reduction, latency reduction, a lesser amount of equalization, and/or other benefits to the switch device 700c.

The out-of-band channels 709 may be used to communicate the out-of-band traffic (e.g., the out-of-band traffic 725 of FIG. 7B) on a lane separate from the multiple lanes used to communicate in-band traffic. In such instances, the out-of-band channels 709 may not cause blocking or interference to the in-band traffic between at least the DSP devices 705a, 705c and the multiple analog ICs 735.

FIG. 7D illustrates an example aggregated switch device 700d. The aggregated switch device 700d may include a first switch device 700aa, an nth switch device 700ac, and multiple analog crossbar switches 740. The first switch device 700aa and the nth switch device 700ac may individually be the same or similar as the switch device 700b of FIG. 7B.

The aggregated switch device 700d illustrates that any number of the switch devices 700b (e.g., the first switch device 700aa and the nth switch device 700ac) may be aggregated into another switch device and/or connected to other analog crossbar switches. Each of the switch devices 700b may include multiple DSP devices and multiple analog IC and may be further aggregated into the aggregated switch device 700d using the multiple analog crossbar switches 740. As such, the aggregated switch device 700d may be scaled up or down for any size communication need, by adjusting the switch devices 700b and/or the multiple analog crossbar switches 740 to meet the communication demand.

As used herein, the singular form of “a”, “an”, and “the” include plural references unless the context clearly dictates otherwise. As used herein, the statement that two or more parts or components are “coupled” shall mean that the parts are joined or operate together either directly or indirectly (i.e., through one or more intermediate parts or components, so long as a link occurs). As used herein, “directly coupled” means that two elements are directly in contact with each other. As used herein, “fixedly coupled” or “fixed” means that two components are coupled so as to move as one while maintaining a constant orientation relative to each other. As used herein, “operatively coupled” means that two elements are coupled in such a way that the two elements function together. It is to be understood that two elements “operatively coupled” does not require a direct connection or a permanent connection between them. As utilized herein, “substantially” means that any difference is negligible, or that such differences are within an operating tolerance that are known to persons of ordinary skill in the art and provide for the desired performance and outcomes as described in one or more embodiments herein. Descriptions of numerical ranges are endpoints inclusive.

As used herein, the word “unitary” means a component is created as a single piece or unit. That is, a component that includes pieces that are created separately and then coupled together as a unit is not a “unitary” component or body. As employed herein, the statement that two or more parts or components “engage” one another shall mean that the parts exert a force against one another either directly or through one or more intermediate parts or components. As employed herein, the term “number” shall mean one or an integer greater than one (i.e., a plurality). Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

Embodiments described as being implemented in hardware should not be limited thereto, but can include embodiments implemented in software, or combinations of software and hardware, and vice-versa, as will be apparent to those skilled in the art, unless otherwise specified herein. In the exemplary embodiments described herein, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The embodiments described herein may be embodied in systems, apparatus, methods, computer programs and/or articles depending on the desired configuration. Any methods or the logic flows depicted in the accompanying figures and/or described herein do not necessarily require the particular order shown, or sequential order, to achieve desirable results. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. The implementations described above can be directed to various combinations and subcombinations of the disclosed features and/or combinations and subcombinations of further features noted above. Furthermore, above described advantages are not intended to limit the application of any issued claims to processes and structures accomplishing any or all of the advantages. Furthermore, any reference to this disclosure in general or use of the word “embodiment” in the singular is not intended to imply any limitation on the scope of the claims set forth below. Multiple embodiments may be set forth according to the limitations of the multiple claims issuing from this disclosure, and such claims accordingly define the embodiment(s) herein, and their equivalents, that are protected thereby.

In the claims, any reference signs placed between parentheses shall not be construed as limiting the claim. The word “comprising” or “including” does not exclude the presence of elements or steps other than those listed in a claim. In a device claim enumerating several means, several of these means may be embodied by one and the same item of hardware. The word “a” or “an” preceding an element does not exclude the presence of a plurality of such elements. In any device claim enumerating several means, several of these means may be embodied by one and the same item of hardware. The mere fact that certain elements are recited in mutually different dependent claims does not indicate that these elements cannot be used in combination.

Although the description provided above provides detail for the purpose of illustration based on what is currently considered to be the most practical and preferred embodiments, it is to be understood that such detail is solely for that purpose and that the disclosure is not limited to the expressly disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

1. A device, comprising:
a processor operable to process one or more of layer 2 (L2) or layer 3 (L3) protocols, wherein the processor includes handling of one or more of frame headers, frame boundaries, media access control (MAC) addresses, or internet protocol (IP) addresses;
a MAC address and an IP address associated with the device, wherein the device is operable to:
receive and process data packets addressed to the MAC or the IP address of the device,
wherein the device is further operable to interface with layer 1 (L1) devices, including layer 1 systems and physical transceivers (PHYs).

2. The device of claim 1, wherein the device is operable to process both L2 and L3 packet headers simultaneously during data reception and forwarding to facilitate real-time MAC address lookup and IP routing.

3. The device of claim 1, wherein the device is operable to configure one or more of a network switch or crossbar by responding to requests for connectivity or resource allocation based on received packet information.

4. The device of claim 1, wherein the device is operable to send packets containing status information about the device or a coupled system, wherein the status information includes one or more of performance metrics or operational status.

5. The device of claim 1, wherein the device is operable to:
configure itself or a coupled system in response to received packet information; and
transmit one or more of responses or status updates related to the device or the coupled system based on the processed data packets.

6. The device of claim 1, wherein the processor is operable with one or more of 5G or WiFi.

7. A device, comprising:
an integrated Layer 2 (L2) and Layer 3 (L3) processor, wherein the processor is operable to:
store and manage one or more of media access control (MAC) address tables or internet protocol (IP) routing tables;
store and apply priority levels associated with entries in the one or more of MAC address tables or IP routing tables;
configure and control a crossbar based on Layer 1 (L1), L2, or L3 communication.

8. The device of claim 7, wherein the device is further operable to:
receive communication containing one or more of frame headers or packet headers addressed to the device;
detect and decode the one or more of frame headers or packet headers within the L1 processing layer of the device; and
configure, based on the one or more of the frame headers or the packet headers, one or more of crossbars or switches to provide connectivity between two or more endpoints in a network.

9. The device of claim 7, wherein the one or more of the MAC address tables or IP routing tables are stored locally within the device and are updated based on incoming packet headers and associated metadata.

10. The device of claim 7, wherein the device configures crossbars to establish connections between two MAC addresses stored in a MAC address lookup table (LUT) and dynamically adjust routing based on the state of a network.

11. The device of claim 7, wherein the device is operable to apply priority levels associated with different entries in the one or more of the MAC address tables or IP routing tables to manage data flows and bandwidth allocation.

12. The device of claim 7, wherein the crossbar is a network switch that interfaces with multiple DSPs, and the device is further operable to communicate with the crossbar to dynamically update switch configurations based on L2 or L3 packet inspection.

13. The device of claim 7, wherein the device provides a communication path between multiple endpoints by dynamically configuring the crossbar based on real-time network traffic conditions and requests.

14. A device, comprising:
a digital signal processor (DSP) operable to perform packet inspection and processing, wherein the DSP is operable to:
receive data packets containing one or more of frame headers or packet headers;
perform inspection of Layer 2 (L2) and Layer 3 (L3) headers, including one or more of media access control (MAC) addresses and internet protocol (IP) addresses;
process the data packets to generate forwarding decisions; and
configure network components based on the results of packet processing.

15. The device of claim 14, wherein the device is further operable to optimize latency by facilitating parallel processing of packet headers and by dynamically adjusting one or more of network paths or configurations based on the results of the packet processing.

16. The device of claim 14, wherein the DSP is operable to inspect L2 and L3 headers to facilitate one or more of routing or switching packets within a network.

17. The device of claim 14, wherein the DSP is operable to perform packet inspection and header decoding for incoming packets within a predefined low-latency threshold.

18. The device of claim 14, wherein the device dynamically configures one or more of crossbars or switches based on the results of the packet inspection to facilitate directing data traffic along a network path to reduce latency when compared to a baseline.

19. The device of claim 14, wherein the DSP is programmed to apply traffic prioritization policies during packet inspection to facilitate higher-priority data to be processed with reduced latency when compared to a baseline.

20. The device of claim 14, wherein the device communicates backpressure signals to other network components based on the packet inspection to prevent congestion by adjusting data transmission rates from upstream devices.
